(19) United States
(12) Patent Application Publication
(10) Pub. No.: US 2025/0377677 A1
(43) Pub. Date: Dec. 11, 2025

(54) INTELLIGENT CONTROL SYSTEM AND METHOD FOR CIRCULATING COOLING WATER BASED ON THE INTERNET OF THINGS

(71) Applicant: NORTH UNITED ELECTRIC POWER CO., LTD. BAOTOU NO.2 THERMAL POWER PLANT, Batou City (CN)

(72) Inventors: Yan Lu, Batou City (CN); Xiaoming Su, Batou (CN); Ke Wang, Batou City (CN); Jun Li, Batou City (CN); Ruihao Zhan, Batou City (CN); Ye Lin, Batou City (CN)

(73) Assignee: NORTH UNITED ELECTRIC POWER CO., LTD. BAOTOU NO.2 THERMAL POWER PLANT, Batou City (CN)

(21) Appl. No.: 19/286,207

(22) Filed: Jul. 30, 2025

(30) Foreign Application Priority Data
Oct. 30, 2024 (CN) 202411530788.7

(51) Int. Cl. G05D 23/19; F28F 27/00; G05B 13/02; G05B 13/04

(52) U.S. Cl. CPC G05D 23/1917; F28F 27/00; G05B 13/0265; G05B 13/048

(57) ABSTRACT

An intelligent control system and method for circulating cooling water based on Internet of Things is provided. The method includes: pre-deploying sensors, monitoring a circulating cooling water equipment in real time, obtaining circulating cooling water data and transmitting the data to an Internet of Things platform; performing data analysis, determining operation states, dividing a circulating cooling water area, determining current distribution data of circulating cooling water by combining data analysis results; obtaining control distribution data of circulating cooling water, constructing a circulating cooling water intelligent control model, outputting current control data of circulating cooling water according to a circulating cooling water intelligent control strategy and the current distribution data of circulating cooling water, and performing intelligently controlling on the circulating cooling water; and building a circulating cooling water control feedback mechanism, performing periodic feedback control optimization on circulating cooling water intelligent control.

### CROSS-REFERENCE TO RELATED APPLICATIONS

This application it application No. 202411530788.7, filed on Oct. 30, 2024, the content of which is hereby incorporated by reference.

### TECHNICAL FIELD

The disclosure relates to the technical field of cooling water control, and in particular to an intelligent control system and method for circulating cooling water based on the Internet of Things.

### BACKGROUND

With the continuous development of science and technology, the application fields of circulating cooling water equipment are more and more extensive. In order to ensure the stable operation of circulating cooling water equipment during operation, it usually involves temperature control, flow control and pressure control of circulating cooling water. However, a large amount of data will be generated during the operation of circulating cooling water equipment, and the existing control technology mainly carries out overall control, which has low quality and control efficiency.

Therefore, the disclosure provides an intelligent control system and method for circulating cooling water based on the Internet of Things.

### SUMMARY

The disclosure provides an intelligent control system and method for circulating cooling water based on the Internet of Things. By pre-deploying sensors, the circulating cooling water equipment is monitored in real time, and the circulating cooling water data is obtained and transmitted to the Internet of Things platform. Data analysis is performed to determine the operation state of circulating cooling water equipment, divide the circulating cooling water area, and determine the current distribution data of circulating cooling water in combination with the data analysis results; the control distribution data of circulate cooling water is obtained according to the circulate cooling water control requirements, the circulating cooling water intelligent control model is constructed, current control data of the circulating cooling water is output according to the circulating cooling water intelligent control strategy and the current distribution data of the circulating cooling water, and the circulating cooling water is intelligently controlled. A circulating cooling water control feedback mechanism is built, and periodic feedback control optimization is performed on circulating cooling water intelligent control according to intelligent control feedback data of the circulating cooling water. The intelligent control of circulating cooling water is realized.

An intelligent control system for circulating cooling water based on Internet of Things is provided, and includes:
a sensor deployment module, configured for pre-deploying sensors, monitoring a circulating cooling water equipment in real time, obtaining circulating cooling water data and transmitting the data to an Internet of Things platform;
a circulating cooling water distribution module, configured for performing data analysis on the circulating cooling water data transmitted to the Internet of Things platform, determining operation states of the circulating cooling water equipment, dividing a circulating cooling water area, and determining current distribution data of circulating cooling water by combining data analysis results;
an intelligent control module, configured for obtaining control distribution data of circulating cooling water according to circulating cooling water control requirements, constructing a circulating cooling water intelligent control model, outputting current control data of circulating cooling water according to a circulating cooling water intelligent control strategy and the current distribution data of circulating cooling water, and performing intelligently controlling on the circulating cooling water; and
a control feedback module, configured for building a circulating cooling water control feedback mechanism, and performing periodic feedback control optimization on circulating cooling water intelligent control according to intelligent control feedback data of the circulating cooling water.

The intelligent control system for circulating cooling water based on Internet of Things is provided, where the sensor deployment module includes:
a sensor selection unit, configured for selecting a sensor type according to the circulating cooling water control requirements, where the circulating cooling water control requirements includes: a temperature control requirement, a flow control requirement and a pressure control requirement;
a sensor deployment unit, configured for obtaining an equipment layout of the circulating cooling water equipment, determining a flow path of the circulating cooling water, setting flow nodes of the circulating cooling water, and pre-deploying sensors at flow node positions of the circulating cooling water, where pre-deployed sensors include: temperature sensors, flow sensors and pressure sensors; and
a data transmission unit, configured for monitoring the circulating cooling water equipment in real time according to the pre-deployed sensors, obtaining circulating cooling water data and transmitting the data to the Internet of Things platform, where the circulating cooling water data includes: circulating cooling water temperature data, circulating cooling water flow data and circulating cooling water pressure data.

The intelligent control system for circulating cooling water based on Internet of Things is provided, where the circulating cooling water distribution module includes:
a data analysis unit, configured for performing data preprocessing on the circulating cooling water data transmitted to the Internet of Things platform;
storing circulating cooling water data after data preprocessed in the Internet of Things platform according to transmission time sequence, respectively extracting data according to circulating cooling water data types for data analysis, and determining the operation states of the circulating cooling water equipment, where the circulating cooling water data types include: a temperature data type, a flow data type and a pressure data type;
an operation state unit, configured for obtaining normal operation parameter data of the circulating cooling water equipment, and determining a circulating cooling water data range when the circulating cooling water equipment is in the normal operation state, recording as a normal circulating cooling water data range;
when data analysis results show the circulating cooling water data being all in the normal circulating cooling water data range, determining that the circulating cooling water equipment is in the normal operation state;
when the data analysis results show existing circulating cooling water data being not in the normal circulating cooling water data range, determining that the circulating cooling water equipment is in the abnormal operation state; and
a circulating cooling water distribution unit, configured for dividing the circulating cooling water area and determining the current distribution data of the circulating cooling water by combining the data analysis results.

The intelligent control system for circulating cooling water based on Internet of Things is provided, where the circulating cooling water distribution unit includes:
an area dividing block, configured for setting the circulating cooling water area, dividing the circulating cooling water area according to the equipment layout of the circulating cooling water equipment, and determining a circulating cooling water subarea; and
a circulating cooling water distribution block, configured for matching the circulating cooling water subarea with the data analysis results, obtaining operation states and circulating cooling water data of the circulating cooling water subarea, and determining current distribution data of circulating cooling water.

The intelligent control system for circulating cooling water based on Internet of Things is provided, where the intelligent control module further includes:
a control distribution unit, configured for obtaining the control distribution data of circulating cooling water according to the circulating cooling water control requirements;
a model constructing unit, configured for selecting preset models, constructing the circulating cooling water intelligent control model and performing model training on the circulating cooling water intelligent control model of according to the historical circulating cooling water data;
a control strategy unit, configured for determining a control difference value of current circulating cooling water data according to the current distribution data of the circulating cooling water and the control distribution data of the circulating cooling water;
setting a control threshold according to historical circulating cooling water data, and when the control difference value is not lower than the control threshold, marking a corresponding control difference value as a large control difference value;
when the control difference value is low than the control threshold, marking a correspond control difference value as a small control difference value;
obtaining the circulating cooling water intelligent control strategy, matching the current circulating cooling water data with the circulating cooling water intelligent control strategy for one time according to control difference value marking results, matching current circulating cooling water data corresponding to the small control difference value with a predictive control strategy for one time, and matching current circulating cooling water data corresponding to the large control difference value with a real-time control strategy for one time;
obtaining an operation state of a circulating cooling water equipment corresponding to current circulating cooling water data of an one-time matching predictive control strategy, and maintaining one-time matching when the operation state of the corresponding circulating cooling water equipment is a normal operation state;
performing secondary matching when the operation state of the corresponding circulating cooling water equipment is an abnormal operation state, and switching the real-time control strategy;
an intelligent control unit, configured for applying the circulating cooling water intelligent control strategy, inputting the control difference value of current circulating cooling water data into the circulating cooling water intelligent control model after model training, and outputting the current control data of circulating cooling water;

$$u i 1 = \frac{1}{n 1} {\sum }_{i 1 = 1}^{n 1} ( \frac{yi 1 - xi 1}{yi 1} ) \cdot ( ( yi 1 - xi 1 ) + a 1 {\int }_{0}^{t 1} ( yi 1 - xi 1 ) dt 1 + a 2 \frac{d ( yi 1 - xi 1 )}{dt 1} ) ;$$

where, ui1 represents current control data of circulating cooling water at an i1-th flow node; xi1 represents current distribution data of circulating cooling water at the i1-th flow node; yi1 represents control distribution data of circulating cooling water at the i1-th flow node; (yi1−xi1) represents a control difference value of current circulating cooling water data of the i1-th flow node; t1 represents a current control period of circulating cooling water;

$${\int }_{0}^{t 1} ( yi 1 - xi 1 ) dt 1$$

represents a cumulative control error of circulating cooling water at the i1-th flow node;

$$\frac{d ( yi 1 - xi 1 )}{dt 1}$$

represents an instantaneous control error of circulating cooling water at the i1-th flow node; a1 represents cumulative error control parameters of the circulating cooling water intelligent control model of after model training; a2 represents instantaneous error control parameters of the circulating cooling water intelligent control model after model training; n1 represents a number of flow nodes of circulating cooling water; and
generating control instructions according to the current control data of circulating cooling water, performing intelligently control on the circulating cooling water.

The intelligent control system for circulating cooling water based on Internet of Things is provided, where the control feedback module includes:
a control feedback unit, configured for building a circulating cooling water control feedback mechanism according to the circulating cooling water control requirements and setting control performance evaluation indexes to control and evaluate control effect of the circulating cooling water, where the control performance evaluation indexes include: a temperature control performance evaluation index, a flow control performance evaluation index and a pressure control performance evaluation index; and
according to control evaluation results, generating the circulating cooling water intelligent control feedback data, setting a feedback period, and performing periodic feedback control optimization on the circulating cooling water intelligent control.

The intelligent control system for circulating cooling water based on Internet of Things is provided, further including:
a control visual module, configured for performing visual display processing on a circulating cooling water intelligent control process; and
a control alarm module, configured for setting a circulating cooling water data threshold, and determining corresponding circulating cooling water equipment failure when monitored circulating cooling water data exceeds the circulating cooling water data threshold, and automatically generating fault alarm data.

An intelligent control method for circulating cooling water based on Internet of Things is provided, including:
step 1, monitoring a circulating cooling water equipment in real time, obtaining circulating cooling water data and transmitting the data to an Internet of Things platform;
step 2, performing data analysis on the circulating cooling water data transmitted to the Internet of Things platform, determining operation states of the circulating cooling water equipment, dividing a circulating cooling water area, and determining current distribution data of circulating cooling water by combining data analysis results;
step 3, obtaining control distribution data of circulating cooling water according to circulating cooling water control requirements, constructing a circulating cooling water intelligent control model, outputting current control data of circulating cooling water according to a circulating cooling water intelligent control strategy and the current distribution data of circulating cooling water, and performing intelligently controlling on the circulating cooling water; and
step 4, building a circulating cooling water control feedback mechanism, and performing periodic feedback control optimization on circulating cooling water intelligent control according to circulating cooling water intelligent control feedback data.

Compared with the prior art, the disclosure has the following beneficial effects.

By pre-deploying sensors, the circulating cooling water equipment is monitored in real time, and the circulating cooling water data is obtained and transmitted to the Internet of Things platform. Data analysis is performed to determine the operation state, divide the circulating cooling water area, and determine the current distribution data of circulating cooling water in combination with the data analysis results; the control distribution data of circulate cooling water is obtained, the circulating cooling water intelligent control model is constructed, current control data of the circulating cooling water is output according to the circulating cooling water intelligent control strategy and the current distribution data of the circulating cooling water, and the circulating cooling water is intelligently controlled. A circulating cooling water control feedback mechanism is built, and periodic feedback control optimization is performed on circulating cooling water intelligent control. The intelligent control of circulating cooling water is realized.

Other features and advantages of the disclosure will be set forth in the description which follows, and in part will be obvious from the description, or may be learned by practice of the disclosure. The objects and other advantages of the disclosure may be realized and obtained by the structure particularly pointed out in the written description and the appended drawings.

The technical scheme of the disclosure will be further described in detail with the attached drawings and embodiments.

### BRIEF DESCRIPTION OF THE DRAWINGS

The accompanying drawings are provided to provide a further understanding of the disclosure and constitute a part of the description. The accompanying drawings, together with embodiments of the disclosure, are used to explain the disclosure and may not constitute a limitation of the disclosure. In the attached drawings:

FIG. 1 is a schematic structural diagram of an intelligent control system for circulating cooling water based on Internet of Things according to embodiments of the disclosure; and

FIG. 2 is a flow diagram of an intelligent control system for circulating cooling water based on the Internet of Things according to embodiments of the disclosure.

### DETAILED DESCRIPTION OF THE EMBODIMENTS

Preferred embodiments of the disclosure will be described below with reference to the accompanying drawings, and it should be understood that the preferred embodiments described here are only used to illustrate and explain the disclosure, and are not used to limit the disclosure.

### Embodiment 1

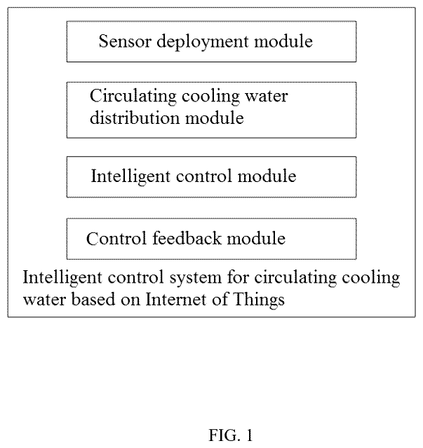

An embodiment of the disclosure provides an intelligent control system for circulating cooling water based on Internet of Things, as shown in FIG. 1, including:
a sensor deployment module, configured for pre-deploying sensors, monitoring a circulating cooling water equipment in real time, obtaining circulating cooling water data and transmitting the data to an Internet of Things platform;
a circulating cooling water distribution module, configured for performing data analysis on the circulating cooling water data transmitted to the Internet of Things platform, determining operation states of the circulating cooling water equipment, dividing a circulating cooling water area, and determining current distribution data of circulating cooling water by combining data analysis results;
an intelligent control module, configured for obtaining control distribution data of circulating cooling water according to circulating cooling water control requirements, constructing a circulating cooling water intelligent control model, outputting current control data of circulating cooling water according to a circulating cooling water intelligent control strategy and the current distribution data of circulating cooling water, and performing intelligently controlling on the circulating cooling water; and
a control feedback module, configured for building a circulating cooling water control feedback mechanism, and performing periodic feedback control optimization on circulating cooling water intelligent control according to intelligent control feedback data of the circulating cooling water.

In this embodiment, the pre-deployed sensors include: a temperature sensor, a flow sensor and a pressure sensor.

In this embodiment, the circulating cooling water equipment refers to the equipment which uses water as the cooling medium and is recycled, and mainly includes: a cooling device, a water pump and a circulating pipeline.

In this embodiment, circulating cooling water data refers to data generated during the operation of circulating cooling water equipment, including temperature data, pressure data and flow data.

In this embodiment, the Internet of Things platform refers to a platform for data analysis and processing of circulating cooling water based on the Internet of Things.

In this embodiment, the operation states of the circulating cooling water equipment include a normal operation state and an abnormal operation state.

In this embodiment, the circulating cooling water area refers to the working area of circulating cooling water, including all equipment layouts of circulating cooling water equipment, including cooling device sub-area, water pump sub-area and circulating pipeline sub-area, which is convenient for subsequent intelligent control of circulating cooling water.

In this embodiment, the current distribution data of circulating cooling water refers to the operation state, temperature distribution, pressure distribution and flow distribution of circulating cooling water equipment at the current moment.

In this embodiment, the circulating cooling water control requirements refer to the control requirements to ensure the stable operation of circulating cooling water, such as temperature control requirements, flow control requirements and pressure control requirements.

In this embodiment, the control distribution data of circulating cooling water refers to the data needed for intelligent control of circulating cooling water, for example, the control distribution data a1 of circulating cooling water, when the current distribution data of circulating cooling water reaches a1, the circulating cooling water equipment operates stably.

In this embodiment, the intelligent control model of circulating cooling water refers to a model for intelligent control of circulating cooling water.

In this embodiment, the circulating cooling water intelligent control strategy refers to the strategy to realize intelligent control of circulating cooling water, including real-time control strategy and predictive control strategy.

In this embodiment, the current control data of circulating cooling water refers to data for controlling the current distribution data of circulating cooling water to control distribution data, for example, the current control data 2 of circulating cooling water is output so that the current distribution data a3 of circulating cooling water is controlled to control distribution data a1 of circulating cooling water.

In this embodiment, the circulating cooling water feedback mechanism refers to a mechanism for controlling and feeding back the circulating cooling water, for example, circulating cooling water intelligent control feedback data is generated and periodic feedback control optimization is performed on circulating cooling water intelligent control.

In this embodiment, the circulating cooling water intelligent control feedback data refers to data used for circulating cooling water periodic intelligent control.

The working principle and beneficial effects of the technical scheme are as follows: by pre-deploying sensors, the circulating cooling water equipment is monitored in real time, and the circulating cooling water data is obtained and transmitted to the Internet of Things platform. Data analysis is performed to determine the operation state, divide the circulating cooling water area, and determine the current distribution data of circulating cooling water in combination with the data analysis results; the control distribution data of circulate cooling water is obtained, the circulating cooling water intelligent control model is constructed, current control data of the circulating cooling water is output according to the circulating cooling water intelligent control strategy and the current distribution data of the circulating cooling water, and the circulating cooling water is intelligently controlled. A circulating cooling water control feedback mechanism is built, and periodic feedback control optimization is performed on circulating cooling water intelligent control. The intelligent control of circulating cooling water is realized.

### Embodiment 2

The embodiment of the disclosure provides the intelligent control system for circulating cooling water based on the Internet of Things, and the sensor deployment module includes:
a sensor selection unit, configured for selecting a sensor type according to the circulating cooling water control requirements, where the circulating cooling water control requirements includes: a temperature control requirement, a flow control requirement and a pressure control requirement;
a sensor deployment unit, configured for obtaining an equipment layout of the circulating cooling water equipment, determining a flow path of the circulating cooling water, setting flow nodes of the circulating cooling water, and pre-deploying sensors at flow node positions of the circulating cooling water, where pre-deployed sensors include: temperature sensors, flow sensors and pressure sensors; and
a data transmission unit, configured for monitoring the circulating cooling water equipment in real time according to the pre-deployed sensors, obtaining circulating cooling water data and transmitting the data to the Internet of Things platform, where the circulating cooling water data includes: circulating cooling water temperature data, circulating cooling water flow data and circulating cooling water pressure data.

In this embodiment, the sensor type is determined according to the circulating cooling water control requirements, for example, the temperature sensor is selected.

In this embodiment, the flow path of circulating cooling water refers to the path of circulating cooling water during operation, for example, a1-a2-a3, where a1, a2 and a3 represent the flow nodes of circulating cooling water.

In this embodiment, the flow node of circulating cooling water refers to a node for dividing the flow path of circulating cooling water, for example, the flow path of circulating cooling water is changed, for example, the corner position is set as the flow node of circulating cooling water.

In this embodiment, the Internet of Things platform refers to a platform for data analysis and processing of circulating cooling water data based on the Internet of Things.

The working principle and beneficial effects of the above technical scheme are as follows: the circulating cooling water equipment is monitored in real time by pre-deploying sensors, and the circulating cooling water data is obtained and transmitted to the Internet of Things platform, thus laying a data foundation for the subsequent intelligent control of circulating cooling water.

### Embodiment 3

The embodiment of the disclosure provides the intelligent control system for circulating cooling water based on Internet of Things, the circulating cooling water distribution module includes:
a data analysis unit, configured for performing data preprocessing on the circulating cooling water data transmitted to the Internet of Things platform; and
storing circulating cooling water data after data preprocessed in the Internet of Things platform according to transmission time sequence, respectively extracting data according to circulating cooling water data types for data analysis, and determining the operation states of the circulating cooling water equipment, where the circulating cooling water data types include: a temperature data type, a flow data type and a pressure data type;
an operation state unit, configured for obtaining normal operation parameter data of the circulating cooling water equipment, and determining a circulating cooling water data range when the circulating cooling water equipment is in the normal operation state, recording as a normal circulating cooling water data range;
when data analysis results show the circulating cooling water data being all in the normal circulating cooling water data range, determining that the circulating cooling water equipment is in the normal operation state; and
when the data analysis results show existing circulating cooling water data being not in the normal circulating cooling water data range, determining that the circulating cooling water equipment is in the abnormal operation state; and
a circulating cooling water distribution unit, configured for dividing the circulating cooling water area and determining the current distribution data of the circulating cooling water by combining the data analysis results.

In this embodiment, the data preprocessing includes: data cleaning and data standardization processing, where the data cleaning is used to eliminate abnormal data and missing data. Data standardization is used to unify data formats.

In this embodiment, the circulating cooling water data after data preprocessing is stored in the Internet of Things platform according to the transmission time sequence, for example, the data with unified transmission time sequence are stored together, which is convenient for subsequent data analysis.

In this embodiment, according to the data types of circulating cooling water, the data are extracted and analyzed respectively, for example, temperature data is extracted for data analysis.

In this embodiment, the normal operation parameter data of the circulating cooling water equipment refers to the data when the circulating cooling water equipment is in a normal operation state, for example, the normal operation temperature parameter data a1.

In this embodiment, the circulating cooling water data range when the circulating cooling water equipment is in the normal operation state refers to the data range composed of the normal operation parameter data of the circulating cooling water equipment, for example, the temperature data range (a1, a2).

In this embodiment, the current distribution data of circulating cooling water refers to the operation state, temperature distribution, pressure distribution and flow distribution of circulating cooling water equipment at the current moment, for example, the temperature data a2 in the circulating cooling water b1 area is in a normal operation state.

The working principle and beneficial effects of the above technical scheme are as follows: by analyzing the circulating cooling water data transmitted to the Internet of Things platform, the operation state of circulating cooling water equipment is determined, and the circulating cooling water area is divided, which is beneficial to the subsequent accurate control of circulating cooling water and the improvement of control quality.

### Embodiment 4

The embodiment of the disclosure provides the intelligent control system for circulating cooling water based on Internet of Things, where the circulating cooling water distribution unit includes:
an area dividing block, configured for setting the circulating cooling water area, dividing the circulating cooling water area according to the equipment layout of the circulating cooling water equipment, and determining a circulating cooling water subarea; and
a circulating cooling water distribution block, configured for matching the circulating cooling water subarea with the data analysis results, obtaining operation states and circulating cooling water data of the circulating cooling water subarea, and determining current distribution data of circulating cooling water.

In this embodiment, the circulating cooling water area refers to the working area of circulating cooling water, including all equipment layouts of circulating cooling water equipment.

In this embodiment, the circulating cooling water sub-area refers to the areas divided according to the equipment layout of the circulating cooling water equipment, such as the cooling device sub-area, the water pump sub-area and the circulating pipeline sub-area.

In this embodiment, the circulating cooling water sub-area is matched with the result of data analysis, and the operation state and circulating cooling water data of the circulating cooling water sub-area are obtained, and the current distribution data of circulating cooling water, for example, the temperature data a2 of circulating cooling water area b1, is determined to be in a normal operation state.

The working principle and beneficial effects of the above technical scheme are as follows: the current distribution data of circulating cooling water is determined by determining the circulating cooling water sub-area and matching with the data analysis result, which is beneficial to the subsequent intelligent control of circulating cooling water.

### Embodiment 5

The embodiment of the disclosure provides the intelligent control system for circulating cooling water based on Internet of Things, where the intelligent control module further includes:
a control distribution unit, configured for obtaining the control distribution data of circulating cooling water according to the circulating cooling water control requirements;
a model constructing unit, configured for selecting preset models, constructing the circulating cooling water intelligent control model and performing model training on the circulating cooling water intelligent control model of according to the historical circulating cooling water data;
a control strategy unit, configured for determining a control difference value of current circulating cooling water data according to the current distribution data of the circulating cooling water and the control distribution data of the circulating cooling water; and
setting a control threshold according to historical circulating cooling water data, and when the control difference value is not lower than the control threshold, marking a corresponding control difference value as a large control difference value;
when the control difference value is low than the control threshold, marking a correspond control difference value as a small control difference value;
obtaining the circulating cooling water intelligent control strategy, matching the current circulating cooling water data with the circulating cooling water intelligent control strategy for one time according to control difference value marking results, matching current circulating cooling water data corresponding to the small control difference value with a predictive control strategy for one time, and matching current circulating cooling water data corresponding to the large control difference value with a real-time control strategy for one time;
obtaining an operation state of a circulating cooling water equipment corresponding to current circulating cooling water data of an one-time matching predictive control strategy, and maintaining one-time matching when the operation state of the corresponding circulating cooling water equipment is a normal operation state; and
performing secondary matching when the operation state of the corresponding circulating cooling water equipment is an abnormal operation state, and switching the real-time control strategy; and
an intelligent control unit, configured for applying the circulating cooling water intelligent control strategy, inputting the control difference value of current circulating cooling water data into the circulating cooling water intelligent control model after model training, and outputting the current control data of circulating cooling water;

$$ui 1 = \frac{1}{n 1} {\sum }_{i 1 = 1}^{n 1} ( \frac{yi 1 - xi 1}{yi 1} ) \cdot ( ( yi 1 - xi 1 ) + a 1 {\int }_{0}^{t 1} ( yi 1 - xi 1 ) dt 1 + a 2 \frac{d ( yi 1 - xi 1 )}{dt 1} ) ;$$

where, ui1 represents current control data of circulating cooling water at an i1-th flow node; xi1 represents current distribution data of circulating cooling water at the i1-th flow node; yi1 represents control distribution data of circulating cooling water at the i1-th flow node; (yi1-xi1) represents a control difference value of current circulating cooling water data of the i1-th flow node; t1 represents a current control period of circulating cooling water;

$${\int }_{0}^{t 1} ( yi 1 - xi 1 ) dt 1$$

represents a cumulative control error of circulating cooling water at the i1-th flow node;

$$\frac{d ( yi 1 - xi 1 )}{dt 1}$$

represents an instantaneous control error of circulating cooling water at the i1-th flow node; a1 represents cumulative error control parameters of the circulating cooling water intelligent control model of after model training; a2 represents instantaneous error control parameters of the circulating cooling water intelligent control model after model training; n1 represents a number of flow nodes of circulating cooling water; and
generating control instructions according to the current control data of circulating cooling water, performing intelligently control on the circulating cooling water.

In this embodiment, control distribution data of circulating cooling water, for example, control distribution data a1 of circulating cooling water is obtained according to the circulating cooling water control requirements, that is, the current distribution data of circulating cooling water is controlled to a1.

In this embodiment, the preset models include a neural network model and a regression model.

In this embodiment, the historical circulating cooling water data refers to the circulating cooling water data obtained in the historical process.

In this embodiment, the control difference value of the current circulating cooling water data refers to the data difference value between the current distribution data of circulating cooling water and the control distribution data of circulating cooling water, for example, the current distribution data a2 of circulating cooling water and the control distribution data a1 of circulating cooling water, then the control difference value of the current circulating cooling water data is a1-a2.

In this embodiment, the control threshold is set according to the historical circulating cooling water data, where the control threshold refers to the control value that the circulating cooling water needs to be intelligently controlled at the current moment, for example, the control threshold a3, and if the control difference value of the current circulating cooling water data exceeds the control threshold a3, the intelligent control is performed at the current period.

In this embodiment, the large control difference value refers to the control difference value that is not lower than the control threshold; the small control difference value refers to the control difference value below the control threshold.

In this embodiment, the greater the control difference value, the priority is given to intelligent control of circulating cooling water.

In this embodiment, the intelligent control strategy of circulating cooling water refers to the strategy of intelligent control of circulating cooling water.

In this embodiment, the real-time control strategy refers to the strategy for circulating cooling water in the current cycle; the predictive control strategy refers to the strategy in the future cycle.

In this embodiment, one-time matching refers to the operation of matching the current circulating cooling water data with the circulating cooling water intelligent control strategy, for example, matching the current circulating cooling water data corresponding to the small control difference value with the predictive control strategy at one time and matching the current circulating cooling water data corresponding to the large control difference value with the real-time control strategy at one time.

In this embodiment, secondary matching refers to the operation of switching real-time control strategies to ensure timely and intelligent control of circulating cooling water.

In this embodiment, the control instruction refers to an instruction for realizing intelligent control of circulating cooling water.

The working principle and beneficial effects of the technical scheme are as follows: the control distribution data of circulating cooling water is obtained according to the circulating cooling water control requirements, a circulating cooling water intelligent control model is constructed, and the current control data of circulating cooling water is output according to the circulating cooling water intelligent control strategy and the current distribution data of circulating cooling water, so that the intelligent control of circulating cooling water is realized.

### Embodiment 6

The embodiment of the disclosure provides the intelligent control system for circulating cooling water based on Internet of Things, where the control feedback module includes:
a control feedback unit, configured for building a circulating cooling water control feedback mechanism according to the circulating cooling water control requirements and setting control performance evaluation indexes to control and evaluate control effect of the circulating cooling water, where the control performance evaluation indexes include: a temperature control performance evaluation index, a flow control performance evaluation index and a pressure control performance evaluation index; and
according to control evaluation results, generating the circulating cooling water intelligent control feedback data, setting a feedback period, and performing periodic feedback control optimization on the circulating cooling water intelligent control.

In this embodiment, the control performance evaluation index is set to control and evaluate the control effect of circulating cooling water, for example, to evaluate the temperature control.

In this embodiment, the feedback period is set, for example, the feedback period t1, that is, the intelligent control of circulating cooling water is performed periodic feedback control optimization according to the intelligent control feedback data of circulating cooling water every t1.

The working principle and beneficial effects of the above technical scheme are as follows: by building the circulating cooling water control feedback mechanism, the intelligent control strategy of circulating cooling water is performed periodic feedback control optimization according to the intelligent control feedback data of circulating cooling water, and the long-term stable intelligent control of circulating cooling water is ensured.

### Embodiment 7

The embodiment of the disclosure provides the intelligent control system for circulating cooling water based on Internet of Things, further including:
a control visual module, configured for performing visual display processing on a circulating cooling water intelligent control process; and
a control alarm module, configured for setting a circulating cooling water data threshold, and determining corresponding circulating cooling water equipment failure when monitored circulating cooling water data exceeds the circulating cooling water data threshold, and automatically generating fault alarm data.

In this embodiment, the intelligent control process of circulating cooling water is performed visual display processing, such as temperature data, pressure data and flow data.

In this embodiment, the threshold value of circulating cooling water data refers to the data upper limit value of circulating cooling water data in normal operation state, for example, the threshold value a1 of circulating cooling water temperature data, and when the temperature data of circulating cooling water exceeds a1, it is determined that the corresponding circulating cooling water equipment is faulty.

In this embodiment, fault alarm data is, for example, temperature fault alarm data.

The working principle and beneficial effects of the above technical scheme are as follows: the intelligent control of circulating cooling water is further ensured by visually displaying the intelligent control process of circulating cooling water and generating fault alarm data.

### Embodiment 8

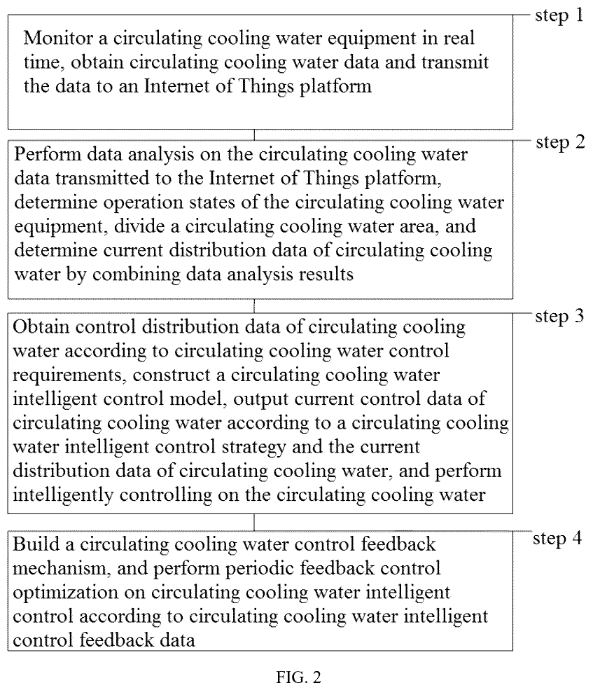

The embodiment of the disclosure provides an intelligent control method for circulating cooling water based on Internet of Things, as shown in FIG. 2, which includes:
step 1, a circulating cooling water equipment is monitored in real time, circulating cooling water data is obtained and transmitted to an Internet of Things platform;
step 2, data analysis is performed on the circulating cooling water data transmitted to the Internet of Things platform, operation states of the circulating cooling water equipment are determined, a circulating cooling water area is divided, and current distribution data of circulating cooling water is determined by combining data analysis results;
step 3, control distribution data of circulating cooling water is obtained according to circulating cooling water control requirements, a circulating cooling water intelligent control model is constructed, current control data of circulating cooling water is outputted according to a circulating cooling water intelligent control strategy and the current distribution data of circulating cooling water, and intelligently controlling is performed on the circulating cooling water; and
step 4, a circulating cooling water control feedback mechanism is built, and periodic feedback control optimization is performed on circulating cooling water intelligent control according to circulating cooling water intelligent control feedback data.

The working principle and beneficial effects of the technical scheme are as follows: by pre-deploying sensors, the circulating cooling water equipment is monitored in real time, and the circulating cooling water data is obtained and transmitted to the Internet of Things platform. Data analysis is performed to determine the operation state, divide the circulating cooling water area, and determine the current distribution data of circulating cooling water in combination with the data analysis results; the control distribution data of circulate cooling water is obtained, the circulating cooling water intelligent control model is constructed, current control data of the circulating cooling water is output according to the circulating cooling water intelligent control strategy and the current distribution data of the circulating cooling water, and the circulating cooling water is intelligently controlled. A circulating cooling water control feedback mechanism is built, and periodic feedback control optimization is performed on circulating cooling water intelligent control. The intelligent control of circulating cooling water is realized.

Finally, it should be explained that the above embodiments are only used to illustrate the technical scheme of the disclosure, but not to limit it. Although the disclosure has been described in detail with reference to the foregoing embodiments, those skilled in the art should understand that it is still possible to modify the technical scheme described in the foregoing embodiments, or to replace some technical features with equivalents. However, these modifications or substitutions may not make the essence of the corresponding technical solutions deviate from the spirit and scope of the technical solutions of various embodiments of the disclosure.

What is claimed is:

1. An intelligent control system for circulating cooling water based on Internet of Things, comprising:
a sensor deployment module, configured for pre-deploying sensors, monitoring a circulating cooling water equipment in real time, obtaining circulating cooling water data and transmitting the data to an Internet of Things platform;
a circulating cooling water distribution module, configured for performing data analysis on the circulating cooling water data transmitted to the Internet of Things platform, determining operation states of the circulating cooling water equipment, dividing a circulating cooling water area, and determining current distribution data of circulating cooling water by combining data analysis results;
an intelligent control module, configured for obtaining control distribution data of circulating cooling water according to circulating cooling water control requirements, constructing a circulating cooling water intelligent control model, outputting current control data of circulating cooling water according to a circulating cooling water intelligent control strategy and the current distribution data of circulating cooling water, and performing intelligently controlling on the circulating cooling water; and
a control feedback module, configured for building a circulating cooling water control feedback mechanism, and performing periodic feedback control optimization on circulating cooling water intelligent control according to intelligent control feedback data of the circulating cooling water;
wherein the intelligent control module comprises:
a control strategy unit, configured for determining a control difference value of current circulating cooling water data according to the current distribution data of the circulating cooling water and the control distribution data of the circulating cooling water;
setting a control threshold according to historical circulating cooling water data, and when the control difference value is not lower than the control threshold, marking a corresponding control difference value as a large control difference value;
when the control difference value is low than the control threshold, marking a correspond control difference value as a small control difference value;
obtaining the circulating cooling water intelligent control strategy, matching the current circulating cooling water data with the circulating cooling water intelligent control strategy for one time according to control difference value marking results, matching current circulating cooling water data corresponding to the small control difference value with a predictive control strategy for one time, and matching current circulating cooling water data corresponding to the large control difference value with a real-time control strategy for one time;
obtaining an operation state of a circulating cooling water equipment corresponding to current circulating cooling water data of an one-time matching predictive control strategy, and maintaining one-time matching when the operation state of the corresponding circulating cooling water equipment is a normal operation state; and
performing secondary matching when the operation state of the corresponding circulating cooling water equipment is an abnormal operation state, and switching the real-time control strategy.

2. The intelligent control system for circulating cooling water based on Internet of Things according to claim 1, wherein the sensor deployment module comprises:
a sensor selection unit, configured for selecting a sensor type according to the circulating cooling water control requirements, wherein the circulating cooling water control requirements comprises: a temperature control requirement, a flow control requirement and a pressure control requirement;
a sensor deployment unit, configured for obtaining an equipment layout of the circulating cooling water equipment, determining a flow path of the circulating cooling water, setting flow nodes of the circulating cooling water, and pre-deploying sensors at flow node positions of the circulating cooling water, wherein pre-deployed sensors comprise: temperature sensors, flow sensors and pressure sensors; and
a data transmission unit, configured for monitoring the circulating cooling water equipment in real time according to the pre-deployed sensors, obtaining circulating cooling water data and transmitting the data to the Internet of Things platform, wherein the circulating cooling water data comprises: circulating cooling water temperature data, circulating cooling water flow data and circulating cooling water pressure data.

3. The intelligent control system for circulating cooling water based on Internet of Things according to claim 2, wherein the circulating cooling water distribution module comprises:
a data analysis unit, configured for performing data preprocessing on the circulating cooling water data transmitted to the Internet of Things platform; and
storing circulating cooling water data after data preprocessed in the Internet of Things platform according to transmission time sequence, respectively extracting data according to circulating cooling water data types for data analysis, and determining the operation states of the circulating cooling water equipment, wherein the circulating cooling water data types comprise: a temperature data type, a flow data type and a pressure data type;
an operation state unit, configured for obtaining normal operation parameter data of the circulating cooling water equipment, and determining a circulating cooling water data range when the circulating cooling water equipment is in the normal operation state, recording as a normal circulating cooling water data range;
when data analysis results show the circulating cooling water data being all in the normal circulating cooling water data range, determining that the circulating cooling water equipment is in the normal operation state; and
when the data analysis results show existing circulating cooling water data being not in the normal circulating cooling water data range, determining that the circulating cooling water equipment is in the abnormal operation state; and
a circulating cooling water distribution unit, configured for dividing the circulating cooling water area and determining the current distribution data of the circulating cooling water by combining the data analysis results.

4. The intelligent control system for circulating cooling water based on Internet of Things according to claim 3, wherein the circulating cooling water distribution unit comprises:
an area dividing block, configured for setting the circulating cooling water area, dividing the circulating cooling water area according to the equipment layout of the circulating cooling water equipment, and determining a circulating cooling water subarea; and
a circulating cooling water distribution block, configured for matching the circulating cooling water subarea with the data analysis results, obtaining operation states and circulating cooling water data of the circulating cooling water subarea, and determining current distribution data of circulating cooling water.

5. The intelligent control system for circulating cooling water based on Internet of Things according to claim 1, wherein the intelligent control module further comprises:
a control distribution unit, configured for obtaining the control distribution data of circulating cooling water according to the circulating cooling water control requirements;
a model constructing unit, configured for selecting preset models, constructing the circulating cooling water intelligent control model and performing model training on the circulating cooling water intelligent control model of according to the historical circulating cooling water data;
an intelligent control unit, configured for applying the circulating cooling water intelligent control strategy, inputting the control difference value of current circulating cooling water data into the circulating cooling water intelligent control model after model training, and outputting the current control data of circulating cooling water, wherein the circulating cooling water intelligent control strategy comprises a real-time control strategy and a predictive control strategy;
$$ui 1 = \frac{1}{n 1} {\sum }_{i 1 = 1}^{n 1} ( \frac{yi 1 - xi 1}{yi 1} ) \cdot ( ( yi 1 - xi 1 ) + a 1 {\int }_{0}^{t 1} ( yi 1 - xi 1 ) dt 1 + a 2 \frac{d ( yi 1 - xi 1 )}{dt 1} ) ;$$
wherein, ui1 represents current control data of circulating cooling water at an i1-th flow node; xi1 represents current distribution data of circulating cooling water at the i1-th flow node; yi1 represents control distribution data of circulating cooling water at the i1-th flow node; (yi1−xi1) represents a control difference value of current circulating cooling water data of the i1-th flow node; t1 represents a current control period of circulating cooling water;
$${\int }_{0}^{t 1} ( yi 1 - xi 1 ) dt 1$$
represents a cumulative control error of circulating cooling water at the i1-th flow node;
$$\frac{d ( yi 1 - xi 1 )}{dt 1}$$
represents an instantaneous control error of circulating cooling water at the i1-th flow node; a1 represents cumulative error control parameters of the circulating cooling water intelligent control model of after model training; a2 represents instantaneous error control parameters of the circulating cooling water intelligent control model after model training; n1 represents a number of flow nodes of circulating cooling water; and
generating control instructions according to the current control data of circulating cooling water, performing intelligently control on the circulating cooling water.

6. The intelligent control system for circulating cooling water based on Internet of Things according to claim 1, wherein the control feedback module comprises:
a control feedback unit, configured for building a circulating cooling water control feedback mechanism according to the circulating cooling water control requirements and setting control performance evaluation indexes to control and evaluate control effect of the circulating cooling water, wherein the control performance evaluation indexes comprise: a temperature control performance evaluation index, a flow control performance evaluation index and a pressure control performance evaluation index; and
according to control evaluation results, generating the circulating cooling water intelligent control feedback data, setting a feedback period, and performing periodic feedback control optimization on the circulating cooling water intelligent control.

7. The intelligent control system for circulating cooling water based on Internet of Things according to claim 1, further comprising:
a control visual module, configured for performing visual display processing on a circulating cooling water intelligent control process; and
a control alarm module, configured for setting a circulating cooling water data threshold, and determining corresponding circulating cooling water equipment failure when monitored circulating cooling water data exceeds the circulating cooling water data threshold, and automatically generating fault alarm data.

8. An intelligent control method for circulating cooling water based on Internet of Things, comprising:
step 1, monitoring a circulating cooling water equipment in real time, obtaining circulating cooling water data and transmitting the data to an Internet of Things platform;
step 2, performing data analysis on the circulating cooling water data transmitted to the Internet of Things platform, determining operation states of the circulating cooling water equipment, dividing a circulating cooling water area, and determining current distribution data of circulating cooling water by combining data analysis results;
step 3, obtaining control distribution data of circulating cooling water according to circulating cooling water control requirements, constructing a circulating cooling water intelligent control model, outputting current control data of circulating cooling water according to a circulating cooling water intelligent control strategy and the current distribution data of circulating cooling water, and performing intelligently controlling on the circulating cooling water; and
step 4, building a circulating cooling water control feedback mechanism, and performing periodic feedback control optimization on circulating cooling water intelligent control according to circulating cooling water intelligent control feedback data;
wherein, step 3 comprises:
determining a control difference value of current circulating cooling water data according to the current distribution data of circulating cooling water and the control distribution data of circulating cooling water;
setting a control threshold according to historical circulating cooling water data, and when the control difference value is not lower than the control threshold, marking a corresponding control difference value as a large control difference value;
when the control difference value is low than the control threshold, marking a correspond control difference value as a small control difference value;
obtaining a circulating cooling water intelligent control strategy, matching the current circulating cooling water data with the circulating cooling water intelligent control strategy for one time according to control difference value marking results, matching current circulating cooling water data corresponding to the small control difference value with a predictive control strategy for one time, and matching current circulating cooling water data corresponding to the large control difference value with a real-time control strategy for one time;
obtaining operation states of the circulating cooling water equipment corresponding to the current circulating cooling water data of an one-time matching predictive control strategy, and maintaining one-time matching when an operation state of the corresponding circulating cooling water equipment is a normal operation state; and
when an operation state of the corresponding circulating cooling water equipment is an abnormal operation state, performing secondary matching and switching the real-time control strategy.
